(19) United States
(12) Patent Application Publication
(10) Pub. No.: US 2026/0160338 A1
(43) Pub. Date: Jun. 11, 2026

(54) FLOW CONTROL APPARATUS

(71) Applicant: ASM IP Holding B.V., Almere (NL)

(72) Inventor: Qichao Hu, Tempe, AZ (US)

(21) Appl. No.: 19/405,664

(22) Filed: Dec. 2, 2025

Related U.S. Application Data
(60) Provisional application No. 63/728,586, filed on Dec. 5, 2024.

(51) Int. Cl. F16K 1/22; F16K 27/02; F16K 49/00

(52) U.S. Cl. CPC F16K 1/223; F16K 27/0218; F16K 49/002

(57) ABSTRACT

A valve assembly comprising: a valve housing operable to couple to a conduit including a restrictor collar centrally disposed within a recess of a valve housing, the restrictor collar comprising an aperture having a first diameter less than a second diameter of a channel within the conduit, wherein a fluid can be transmitted through the aperture of the restrictor collar; and a flapper rotatable relative to the valve housing between an opened position wherein flow through the orifice is at a maximum, and a closed position wherein flow through the aperture is at a minimum.

### CROSS-REFERENCE TO RELATED APPLICATIONS

This application is a nonprovisional of, and claims priority to and the benefit of, U.S. Provisional Patent Application No. 63/728,586 , filed Dec. 5, 2024, and entitled “FLOW CONTROL APPARATUS,” which is hereby incorporated by reference herein.

### FIELD

The disclosure relates generally to control valves for regulating fluid flow through a conduit, and more particularly to valves configured to enable fine-tuning of valve flow control.

### BACKGROUND

A throttle valve (THV) primarily controls the pressure within a system by adjusting the size of the passage through which a fluid flows. It can also regulate the flow rate, but its main function is pressure control. The term “fluid” as used herein refers to a substance that has no fixed shape and yields to external pressure such that it can flow and conform to the shape of its container. Fluids include liquids, gases, and other materials that can continuously move and deform under an applied external force.

Certain throttle valves operate by varying the position of a flapper disc within the valve, which can be adjusted to different positions to control fluid flow and/or pressure. The adjustment can be manual or controlled by a motor and a controller. Throttle valves are used systems including automotive engines, HVAC systems, semiconductor manufacturing tools and other industrial machinery.

A “flapper” is a type of throttle valve that operates to regulate upstream pressure by controlling fluid flow through a conduit. The flow of fluid can be controlled by adjusting a rotatable flapper's position. However, conventional flapper valves are typically unable to fine-tune pressure in systems where the diameter of the conduit is too large to make minor changes to the pressure by changing the flapper position. In such cases, the large diameter makes it difficult to achieve precise control over the pressure, leading to inefficiencies and potential nonconformities in the system.

### SUMMARY

A valve assembly comprising: a valve housing operable to couple to a conduit including a restrictor collar centrally disposed within a recess of a valve housing, the restrictor collar comprising an aperture having a first diameter less than a second diameter of a channel within the conduit, wherein a fluid can be transmitted through the aperture of the restrictor collar; and
a flapper rotatable relative to the valve housing between an opened position wherein flow through the aperture is at a maximum, and a closed position wherein flow through the aperture is at a minimum. The valve assembly, wherein the flapper is rotatable about an axis. The valve assembly, wherein the axis is perpendicular to a flow of fluid in the conduit. The valve assembly, wherein the flapper comprises a corrosion-resistant metal or metallic alloy.

The valve assembly, wherein the flapper is coupled to a rod. The valve assembly, wherein the rod rotates the flapper between 0 and 90 degrees relative to the valve housing. The valve assembly, wherein the rod rotates the flapper between 0 and 360 degrees relative to the valve housing. A valve assembly comprising: a valve housing operable to couple to a conduit including a first flapper disposed within a recess of a valve housing, the first flapper ring comprising an aperture; and a second flapper, wherein the first flapper and the second flapper are rotatable relative to the valve housing between an opened position and a closed position. The valve assembly according to claim 8, wherein the first flapper is a ring comprising an aperture. The valve assembly according to claim 9, wherein the second flapper is disposed within the aperture.

The valve assembly, wherein the first flapper and the second flapper are independently rotatable. The valve assembly, further comprising a compressible node to lock the first flapper and the second flapper together so that they rotate simultaneously. The valve assembly, wherein the first flapper is coupled to a first shaft member and the second flapper is coupled to the second shaft member and wherein the first and second shaft members are operable to independently rotate respective ones of the first flapper and the second flapper.

### BRIEF DESCRIPTION OF THE DRAWINGS

These and other features, aspects and advantages of the present disclosure will now be described with reference to the drawings of several embodiments, which embodiments are intended to illustrate and not to limit the disclosure.

FIG. 1 is a schematic illustrating an example of a semiconductor manufacturing system comprising a reactor assembly;

FIG. 2A is a schematic illustrating an example valve shown in FIG. 1;

FIG. 2B is a schematic illustrating an example valve shown in FIG. 1;

FIG. 2C is a schematic illustrating various flow conductance settings of an example valve shown in FIG. 1;

FIG. 3A is a schematic perspective view of an example valve illustrated in FIG. 1;

FIG. 3B is a schematic perspective view of an example valve illustrated in FIG. 1;

FIG. 3C is a schematic illustrating various flow conductance settings of an example valve shown in FIG. 1.

FIG. 3D is a schematic illustrating various flow conductance settings of an example valve shown in FIG. 1.

FIG. 3E is a schematic illustrating an example of shaft assembly shown in FIG. 3A.

### DETAILED DESCRIPTION

Various embodiments disclosed herein relate to systems and methods for controlling a deposition process in a semiconductor processing device. While embodiments are described in the context of deposition devices (e.g., an atomic layer deposition (ALD) device, a chemical vapor deposition (CVD) device, etc.), the skilled artisan will appreciate application for the principles and advantages taught herein for other types of processing in which overall flow rates and/or pressure may change frequently during processing.

Atomic Layer Deposition (ALD) is a technique used to grow highly uniform thin films on a substrate. In a time-divided ALD reactor, the substrate is placed in a reaction space free of impurities, and at least two different volatile precursors are alternately and repetitively injected in vapor phase. The film growth is based on self-limiting surface reactions that occur on the substrate's surface, forming a solid-state layer of atoms or molecules. The process is highly self-regulating, allowing for extremely high film uniformity and thickness accuracy of a single atomic or molecular layer.

The ALD method can be used to grow both elemental and compound thin films. It involves alternating two or more reactants in cycles, with pure ALD reactions typically producing less than a monolayer per cycle. However, variants of ALD may deposit more than a monolayer per cycle. The process can be slow due to its step-wise nature, requiring at least two gas pulses to form one layer of the desired material. These pulses are kept separate to prevent uncontrolled film growth and contamination of the ALD reactor. Purging is widely used in production to remove gaseous reaction products and excess reactants from the reaction space, employing an inactive gas flow between successive pulses. This helps maintain high film quality and efficiency.

Precise control of a flapper within a throttle valve enables maintenance of stable pressure. Maintaining high pressure, preventing condensation, and ensuring accurate control of the flapper are key technical challenges. Potential solutions include using heater rods to prevent condensation and designing concentric rods for dual-stage control of the throttle valve.

Disclosed here are various examples of single flapper throttle valve that incorporates a restrictor collar to improve pressure control without significantly altering existing hardware and a multiple flapper throttle valve that incorporates concentric flapper discs that are coaxial and controlled by a concentric rod system for multi-stage control, allowing independent control of each flapper disc for more precise adjustments and better pressure management.

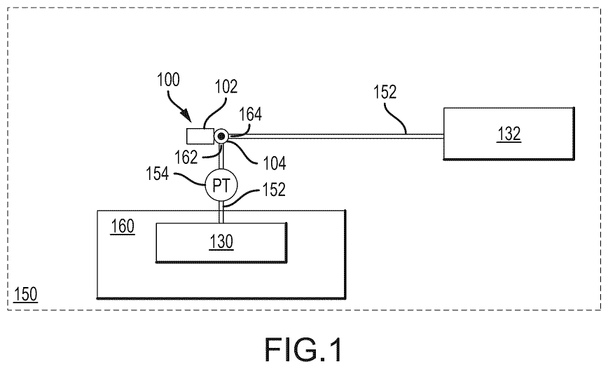

FIG. 1 is a schematic illustrating an example portion of a semiconductor manufacturing system 150 comprising a reactor assembly 160. In an example reactor assembly 160 comprises one or more reaction chamber(s) 130 and is sized to receive a substrate (e.g., a semiconductor wafer) for processing. In an example, an exhaust line 152 is in fluid communication with the reaction chamber 130 and is configured to transfer fluid (e.g., gas) out of the reaction chamber 130 to exhaust module 132. In an example, valve 100 may be located near the exit of reaction chamber (130). In some examples, a valve 100 disposed along the exhaust line 152 is configured to regulate the flow of the fluid. In an example, fluid may enter valve 100 via inlet 162 and exit valve 100 via outlet 164 along exhaust line 152. Valve 100 may comprise a controller 102 and a throttle valve housing 104. In an example valve 100 may comprise a plurality of flow conductance settings (as described in greater detail below). In an example, operation of valve 100 to control flow conductance settings may be manual, automated and/or based on feedback (e.g., in an open loop control system). In an example, one or more pressure transducer(s) 154 may provide feedback to controller 102 comprising pressure data.

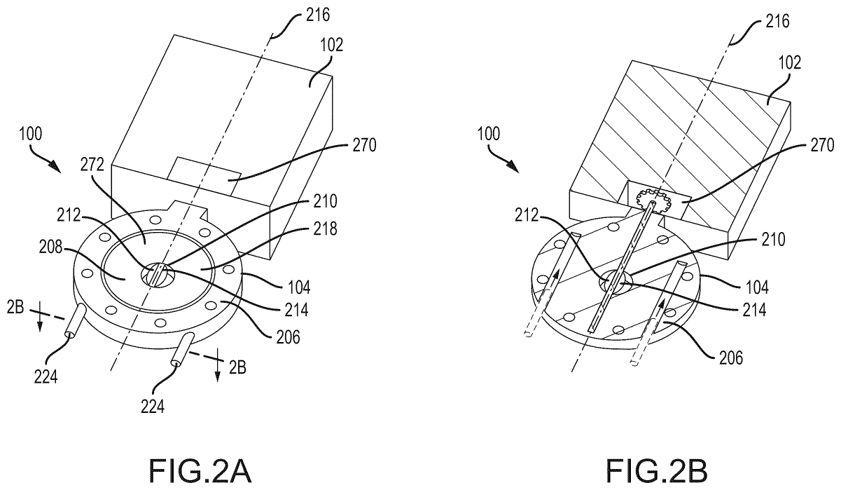

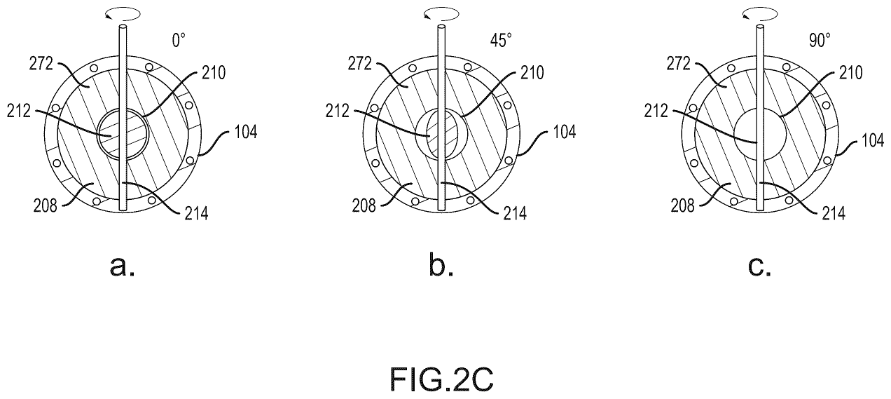

FIG. 2A is a schematic illustrating a perspective view of valve 100. In an example, valve 100 comprises: controller 102 coupled to throttle valve housing 104, flapper 212 disposed within aperture 210 and coupled to a control rod 214, a restrictor collar 208 disposed within a recess 272 in flange 206, and one or more heating element(s) 224 coupled to valve housing 104.

In an example, valve 100 may be coupled to a conduit for transporting a fluid (e.g., liquid or gas) from a first fluid receptacle or holding volume such as a reaction chamber 130 (see FIG. 1) to a second fluid receptacle or holding volume such as an exhaust module 132 (see FIG. 1). Valve 100 may be operable to control the flow of fluid through the conduit and/or to control pressure.

In an embodiment, flapper 212 may comprise a disc (or any shape) that is disposed within an aperture 210. Flapper 212 is coupled to valve housing 104 and/or motor 270 via rod 214. Flapper 212 is configured to rotate about axis 216 within aperture 210 from a closed position to a fully open position.

In an example, restrictor collar 208 may be operable to control the flow of fluids through the conduit (e.g., exhaust line 152 shown in FIG. 1) by introducing a deliberate constriction within the flow path of the throttle valve 100. This constriction reduces the diameter of the conduit at a specific point, which may result in a pressure drop and flow restriction. Restrictor collar 208 may enable fine-tuning control of the flow rate and pressure of fluid passing through the throttle valve housing 104. When the fluid flows through the restrictor collar 208, its velocity increases, and its pressure decreases. By selecting the size and shape of the restrictor collar 208 the flow rate and pressure drop across the throttle valve can be more finely tuned than in conventional throttle valves without having to replace the conduit with a smaller diameter conduit. Precise control of the flapper 212 improves ability to maintain stable pressure in system 150. By adding the restrictor collar 208, clearance between the flapper 212 and an inner diameter of the restrictor collar 208 versus a flapper 212 and an inner diameter of valve housing 104 may be reduced.

In an example, controller 102 regulates fluid flow in a conduit such as exhaust line 152 (see FIG. 1) by adjusting the position of flapper 212. Flapper 212 may be adjusted to discreet or continuous flow control settings. Adjustments to flapper 212 settings can be made responsive to or based on pressure feedback in order to tune fluid flow within a conduit and/or within the reaction chamber 130. The controller 102 may directly control motor 270, which is configured to rotate rod 214 to adjust the position of flapper 212 to maintain the desired pressure and/or flow.

In certain embodiments, condensation and/or chemistry may buildup on one or more components of valve 100 which may affect the throttle valve's accuracy and responsiveness. In an example, heater rod(s) 224 may be coupled to or integrated into the valve housing 104. This may prevent condensation or other unwanted build-up.

FIG. 2B is a schematic illustrating a cutaway view of valve 100 about cutting plane AB shown in FIG. 2A (arrows showing the direction of the view). In an example, flapper 212 is mounted within aperture 210 on a rod 214. Rod 214 extends into controller 102. Motor 270 contacts and controls rod 214 movement, adjusting the flapper 212's position to regulate flow and pressure. The flapper 212 may be adjusted to various positions, from fully open to fully closed. In an example, rod 214 may rotate causing flapper 212 to rotate within aperture 210. A clearance is provided to ensure flapper 212 can freely rotate within aperture 210. Flapper 212 may rotate about axis 216 from a closed position at 0° (see panel a of FIG. 2C) with respect to the plane 218 of the aperture 210 to an open position at 90° (see panel c of FIG. 2C) with respect to plane 218. In certain examples, flapper 212 may rotate about axis 216 from 0° to at least 360° such as to 45° (see panel b of FIG. 2C) and claimed subject matter is not limited in this regard.

Fluid flows through the conduit from an inlet 162 to an outlet 164 with the aperture 210 providing a passage for the fluid as it moves through the valve 100. Flapper 212 is rotatably mounted within the aperture 210 and is configured to rotate about an axis. The rotational movement of the flapper 212 controls the flow of fluid through the valve. In the closed position the flapper 212 is positioned at 0° relative to the plane of the aperture 210 opening. In this position the flapper 212 is essentially aligned with the aperture 210 obstructing the flow path and preventing fluid from passing through the valve 100. In the open position the flapper 212 is rotated to 90° relative to the plane of the aperture 210 opening. In this orientation the flapper 212 is perpendicular to the flow path allowing fluid to pass freely through the aperture 210 from the inlet 162 to the outlet 164 with minimal resistance. the angular rotation of the flapper 212 from 0° closed to 90° open is controlled by an actuator which engages the flapper 212 to precisely regulate the fluid flow through the valve the closed position corresponds to 0° aligned with the plane of the aperture and the open position corresponds to 90° perpendicular to the plane of the aperture 210. In an example, valve 100 may be constructed have any appropriate material known to those of skill in the art. For example, one or more of housing 104, flapper 212, aperture 210, rod 214, restrictor collar 208, heating element(s) 224, may comprises a corrosion-resistant metal or metallic alloy.

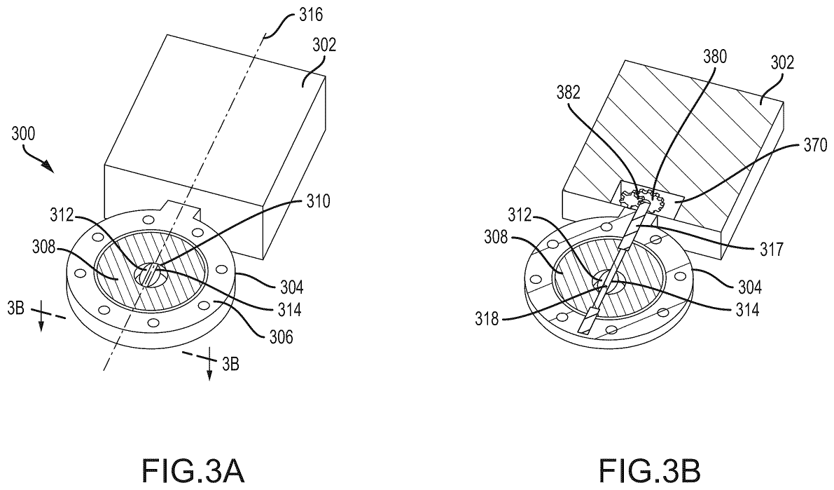

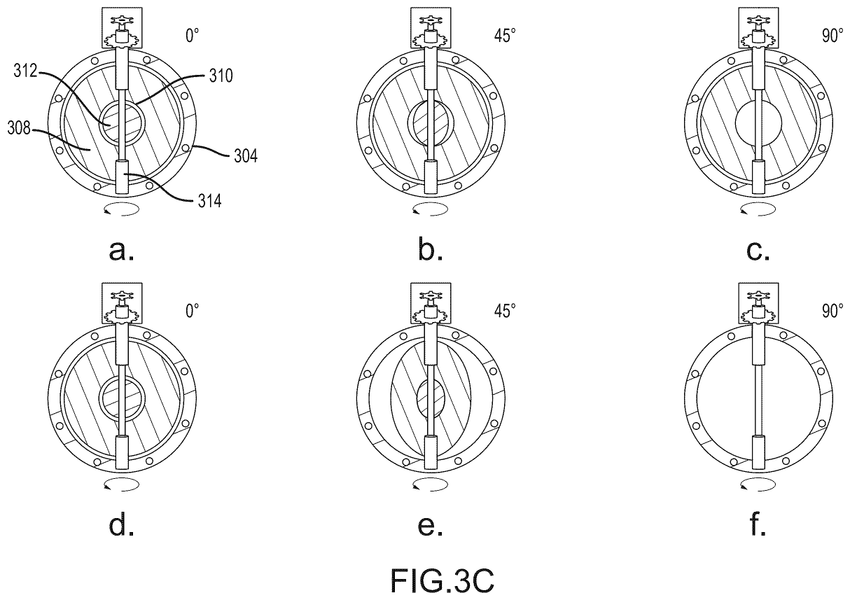

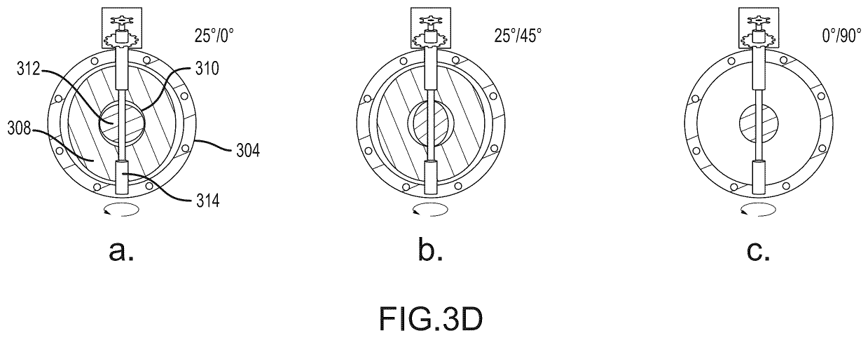

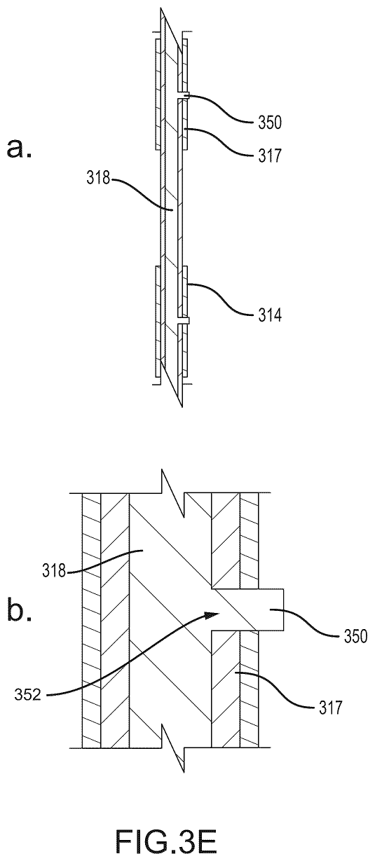

FIG. 3A is a schematic illustrating a perspective view of valve 300. In an example, valve 300 comprises: controller 302 coupled to throttle valve housing 304, outer flapper 308 and inner flapper 312 disposed concentrically with flapper 308 within aperture 310. outer flapper 308 and inner flapper 312 are coupled to respective portions of shaft assembly 314. Valve 300 also includes flange 306. In an example, valve 300 may be coupled to a conduit for transporting a fluid (e.g., liquid or gas) from a first fluid receptacle or holding volume such as a reaction chamber 130 (see FIG. 1) to a second fluid receptacle or holding volume such as an exhaust module 132 (see FIG. 1). Valve 300 may be operable to control the flow of fluid through the conduit and/or to control pressure. In an embodiment, flapper 308 may comprise a ring and flapper 312 may comprise a disc (or any shape) that is disposed within an aperture 310. Flappers 308 and 312 are coupled to valve housing 304 and/or motor 370 via shaft assembly 314. Flappers 308 and 312 are configured to rotate about axis 316 from a closed position to a fully open position. Flappers 308 and 312 may rotate independently or simultaneously.

In an example, flapper 308 may be held in a closed position and may be operable to control the flow of fluids through the conduit (e.g., exhaust line 152 shown in FIG. 1) by introducing a constriction within the flow path of the throttle valve 300.

In an example, controller 302 regulates fluid flow in a conduit such as exhaust line 152 (see FIG. 1) by adjusting the position of flappers 308 and 312. Flappers 308 and 312 may be adjusted to discreet or continuous flow control settings. Adjustments to flappers 308 and 312 settings can be made responsive to or based on pressure feedback in order to tune fluid flow within a conduit and/or within the reaction chamber 130. The controller 302 may directly control motor 370, which is configured to rotate members of shaft assembly 314 to adjust the position of flappers 308 and 312 to maintain the desired pressure and/or flow.

FIG. 3B is a schematic illustrating a cutaway view of valve 300 about cutting plane AB shown in FIG. 3A (arrows showing the direction of the view). In an example, flappers 308 and 312 are mounted within valve housing 304 on coupled to shaft assembly 314. Shaft assembly 314 extends into controller 302. Motor 370 contacts and controls shaft assembly 314 movement, adjusting the flappers 308 and 312's position to regulate flow and pressure. The flappers 308 and 312 may be adjusted to various positions, from fully open to fully closed. In an example, shaft assembly 314 may rotate causing flappers 308 and 312 to rotate. A clearance is provided to ensure flappers 308 and 312 can freely rotate within valve housing 304. Flappers 308 and 312 may rotate about axis 316 from a closed position at 0° with respect to the plane of the aperture 310 (see panel d of FIG. 3C showing both flappers 308 and 312 in a closed position) to an open position at 90° (see panel f of FIG. 3C showing both flappers 308 and 312 in an open position at 90°) with respect to the plane of aperture 310. In certain examples, flappers 308 and 312 may rotate about axis 316 from 0° to at least 360° such as to 45° (see panel e of FIG. 3C) and claimed subject matter is not limited in this regard. In some embodiments, flapper 312 may rotate about axis 316 while flapper 308 remains closed at 0° with respect to the plane of the aperture 310 (see panels a-c of FIG. 3C) showing flapper 312 only rotating from 0° in panel a to 45° in panel b and to 90° in panel c. In certain examples, flappers 308 and 312 may rotate independently about axis 316. For example, see FIG. 3D illustrating flapper 308 at 25° and flapper 312 at 0° in panel a, flapper 308 at 25° and flapper 312 at 45° in panel b, and flapper 308 at 0° and flapper 312 at 90° in panel c. Various other configurations of flappers 308 and 312 positions are contemplated.

In some examples, fluid flows through the conduit from an inlet 162 to an outlet 164 with the aperture 310 providing a passage for the fluid as it moves through the valve 300. Flappers 308 and 312 are rotatably mounted within the aperture 310 and are configured to rotate about an axis. The rotational movement of the flappers 308 and 312 controls the flow of fluid through the valve 300. In the closed position the flappers 308 and 312 are essentially aligned with the aperture 310 obstructing the flow path and preventing fluid from passing through the valve 300. In the open position the flappers 308 and 312 are rotated to 90° relative to the plane of the aperture 310 opening. In this orientation the flappers 308 and 312 are perpendicular to the flow path allowing fluid to pass freely through the aperture 210 from the inlet 162 to the outlet 164 (see FIG. 1) with minimal resistance, the angular rotation of the flappers 308 and 312 from 0° closed to 90° open can be controlled by respective actuators 380 and 382 which engages the respective flappers 308 and 312 to precisely regulate the fluid flow through the valve the closed position corresponds to 0° aligned with the plane of the aperture 310 and the open position corresponds to 90° perpendicular to the plane of the aperture.

In an example, valve 300 may be constructed have any appropriate material known to those of skill in the art. For example, one or more of housing 304, flappers 308 and 312, aperture 310, and/or shaft assembly 314 may comprise a corrosion-resistant metal or metallic alloy.

FIG. 3A, FIG. 3B and FIG. 3E illustrate a shaft system comprising a shaft assembly 314 for controlling one or more concentric flappers (e.g., flappers 308 and 312) that are coaxial with the shaft assembly 314. In an example, shaft assembly 314 is configured to allow independent rotation of the concentric flappers relative to the shaft assembly 314 and to utilize a compressible node 350 comprising a locking mechanism to secure the shaft assembly 314 in a stationary position. When needed the motorized system includes a central shaft assembly 314 which serves as the primary axis of rotation 316 for the system. Shaft assembly 314 is coaxial with one or more concentric flappers along the primary axis of rotation 316.

Shaft assembly 314 may comprise a plurality of shaft members for example first shaft assembly member 317 and a second shaft assembly member 318. In an example, outer flapper 308 is coupled to shaft assembly member 317 and inner flapper 312 is coupled to shaft assembly member 318.

In an example, controller 302 and motor 370 may rotate shaft assembly member 317 to control rotation and outer flapper 308. Controller 302 and motor 370 may rotate shaft assembly member 318 to independently control rotation of inner flapper 312. In an example concentric flappers are supported by other mechanical structures to permit free rotation about the shaft assembly 314 the rotation of each concentric flapper is independently controlled by motorized actuators 380 and 382 (such as stepper motors, servos, or electric) motors mounted along the length of the shaft assembly 314 are integrated within the system these motors drive individual rotational couplings that may be mechanically connected to each of the concentric flappers 308 and 312. These couplings transmit rotational motion from the motorized actuators to the concentric flappers allowing each flapper to be rotated independently without affecting the other concentric elements. in one embodiment, each motorized actuator is equipped with a feedback mechanism such as an encoder or sensor which allows precise control of the rotational position of the concentric flappers. This allows for synchronized or independent motion depending on the system requirements to secure the shaft assembly 314 in a fixed position. In certain embodiments, shaft assembly 314 incorporates one or more compressible node 350 as illustrated in panels A&B of FIG. 3E. In an example, compressible node 350 may be coupled to and is configured to maye to shaft locking cavity 352. Thus, compressible node 350 is capable of locking the assembly 314 in place to rotate both flapper 308 and 312 simultaneously. The compressible node 350 is positioned at a specified point along the length of the shaft 314 and is designed to engage the outer surface of the shaft when activated. When the shaft assembly 314 needs to be unlocked the compressible node 350 can be deactivated or otherwise disengaged. The node 350 may release from cavity 352 and allow the shaft assembly members 317 and 318 to rotate freely again. This locking and unlocking process can be controlled electronically or manually depending on the application and may be implemented using any compressible locking mechanisms known to those of skill in the art.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The headings provided herein, if any, are for convenience only and do not necessarily affect the scope or meaning of the devices and methods disclosed herein.

What is claimed is:

1. A valve assembly comprising:
a valve housing operable to couple to a conduit including a restrictor collar centrally disposed within a recess of the valve housing, the restrictor collar comprising an aperture having a first diameter less than a second diameter of a channel within the conduit, wherein a fluid can be transmitted through the aperture of the restrictor collar; and
a flapper rotatable relative to the valve housing between an opened position wherein flow through the aperture is at a maximum, and a closed position wherein flow through the aperture is at a minimum.

2. The valve assembly according to claim 1, wherein the flapper is rotatable about an axis.

3. The valve assembly according to claim 2, wherein the axis is perpendicular to a flow of fluid in the conduit.

4. The valve assembly according to claim 1, wherein the flapper comprises a corrosion-resistant metal or metallic alloy.

5. The valve assembly according to claim 1, wherein the flapper is coupled to a rod.

6. The valve assembly according to claim 5, wherein the rod rotates the flapper between 0 and 90 degrees relative to the valve housing.

7. The valve assembly according to claim 5, wherein the rod rotates the flapper between 0 and 360 degrees relative to the valve housing.

8. A valve assembly comprising:
a valve housing operable to couple to a conduit including a first flapper disposed within a recess of the valve housing, the first flapper comprising an aperture; and
a second flapper, wherein the first flapper and the second flapper are rotatable relative to the valve housing between an opened position and a closed position.

9. The valve assembly according to claim 8, wherein the first flapper is a ring comprising the aperture within the ring.

10. The valve assembly according to claim 9, wherein the second flapper is disposed within the aperture.

11. The valve assembly according to claim 10, wherein the first flapper and the second flapper are independently rotatable.

12. The valve assembly according to claim 8, further comprising a compressible node to lock the first flapper and the second flapper together so that they rotate simultaneously.

13. The valve assembly according to claim 8, wherein the first flapper is coupled to a first shaft member and the second flapper is coupled to the second shaft member.

14. The valve assembly according to claim 13, wherein the first and second shaft members are operable to independently rotate respective ones of the first flapper and the second flapper.
